(19) United States
(12) Patent Application Publication
(10) Pub. No.: US 2025/0251588 A1
(43) Pub. Date: Aug. 7, 2025

(54) OPTICAL SCANNING DEVICE AND IMAGE FORMING APPARATUS

(71) Applicant: CANON KABUSHIKI KAISHA, Tokyo (JP)

(72) Inventors: NAOKI MATSUSHITA, Shizuoka (JP); KAZUSHI INO, Tokyo (JP)

(21) Appl. No.: 19/041,912

(22) Filed: Jan. 30, 2025

(30) Foreign Application Priority Data
Feb. 6, 2024 (JP) 2024-016440

(51) Int. Cl. G02B 26/12; B41J 2/44; B41J 2/47; B41J 29/00; G03G 15/00; G03G 15/04; G03G 15/043; H04N 1/028

(52) U.S. Cl. CPC G02B 26/12; B41J 2/442; B41J 2/471; B41J 29/00; G03G 15/04036; G03G 15/0435; G03G 15/80; H04N 1/0283

(57) ABSTRACT

An optical scanning device includes a polygon mirror, a motor driving the polygon mirror, a substrate on which the polygon mirror and the motor are mounted, and a connector mounted on the substrate using a surface mount technology. The connector is provided with a plurality of terminal pins including vertical portions extending substantially in a vertical direction with respect to a plane of the substrate and bonding portions bonded to a surface of the substrate by solder. In the plurality of terminal pins, each of leading ends of the bonding portions faces in a same first direction. In a state in which a cable which sends an electric power and an electric signal to the motor is connected to the connector, the cable is connected to the connector so as to extend in a second direction opposite to the first direction.

### FIELD OF THE INVENTION AND RELATED ART

The present invention relates to an optical scanning device, which scans a scanned object with a laser beam corresponding to image information, and to an image forming apparatus using an electrophotographic recording type, such as a laser beam printer, equipped with the optical scanning device.

FIG. 6 is a perspective view of a conventional optical scanning device, and FIG. 7 is a cross-sectional view of a conventional connector connecting a cable, which sends a signal for driving a scanner motor. A connector 306 includes four terminal pins 310 of round shape and is a connector of straight type, of which the terminal pins 310 connected to a connector cable 308 extend in a vertical direction with respect to a substrate 307. And the connector 306 is mounted, without the terminal pins 310 penetrating the substrate 307, on a surface of the substrate 307 with solder using a surface mount technology. Furthermore, the connector 306 is provided so that a leading end of a solder bonding portion 309 of the four terminal pins 310 is in an opposite direction to a direction toward a position of the substrate 307, at which a rotating polygon mirror 302 is mounted (see, for example, Japanese Patent Application Laid-Open No. 2021-056446). In addition, the connector cable 308 connected to the connector 306 extends in the same direction (D308) as a direction (D310) directing from a bent portion R of the terminal pin 310 to the leading end of the solder bonding portion 309, and avoids shading of a laser light L by the connector cable 308 (see, for example, Japanese Patent Application Laid-Open No. H11-133336). In addition, if a connector cable connected to a scanner motor has an extra length, it causes increase of cost, and the connector cable may also be pinched by components near where the connector cable is routed and experience wire breakage. Therefore, it is necessary for the connector cable to be routed with a minimum length. Therefore, when the connector cable 308 is routed in a state of being connected to the connector 306, to the connector 306, tensile stress is being generated to the direction of the leading end of the solder bonding portion 309 of the terminal pin 310 (direction of D310).

However, in cases of the conventional technology as described above, there is a problem as below. That is, in a case in which the connector 306 is mounted on the surface of the substrate 307 using the surface mount technology, a fillet (spreading) 314 is formed in a solder 313 which bonds the solder bonding portion 309 of the terminal pins 310 and the substrate 307. In the case in which the terminal pin 310 has the round shape (is a round pin), as to a leading end portion 315 of the solder fillet 314 formed at the bent portion R of the terminal pin 310, a bonded area with respect to the substrate 307 is tapered. Therefore, when force is applied to the connector 306 in the direction D310, tensile stress is concentrated on the leading end portion 315 of the solder fillet 314 formed at the bent portion R of the terminal pin 310, which may become a starting point of solder breakdown and cause the connector 306 to be detached from the substrate 307.

### SUMMARY OF THE INVENTION

The present invention is conceived under such a circumstance, and an object of the present invention is to suppress detachment of a connector of a scanner motor.

According to an aspect of the present invention, there is provided an optical scanning device comprising: a light source configured to emit a laser light; a rotating polygon mirror configured to deflect the laser light emitted from the light source; an optical member configured to guide the laser light deflected by the rotating polygon mirror to a scanned member; a motor configured to rotate the rotating polygon mirror; a substrate on which the rotating polygon mirror and the motor are mounted; an optical box configured to accommodate the substrate and the optical member; an optical lid configured to close an opening surface of the optical box; and a connector mounted on the substrate using a surface mount technology, wherein the connector is provided with a plurality of terminal pins including vertical portions extending substantially in a vertical direction with respect to a plane of the substrate and bonding portions bonded to a surface of the substrate by solder, wherein in the plurality of terminal pins, each of leading ends of the bonding portions faces in a same first direction, and wherein in a state in which a cable which sends an electric power and an electric signal to the motor is connected to the connector, the cable is connected to the connector so as to extend in a second direction opposite to the first direction.

Further features of the present invention will become apparent from the following description of exemplary embodiments with reference to the attached drawings.

### BRIEF DESCRIPTION OF THE DRAWINGS

FIG. 1 is a schematic cross-sectional view illustrating an image forming apparatus in an Embodiment.

FIG. 2 is a perspective view of an optical scanning device in the Embodiment.

FIG. 3 is a cross-sectional view of a connector in the Embodiment.

FIG. 4 is a view illustrating a Modified Example of the optical scanning device in the Embodiment.

FIG. 5 is a view illustrating a Modified Example of the optical scanning device in the Embodiment.

FIG. 6 is a perspective view of an optical scanning device in a conventional example.

FIG. 7 is a cross-sectional view of a conventional connector.

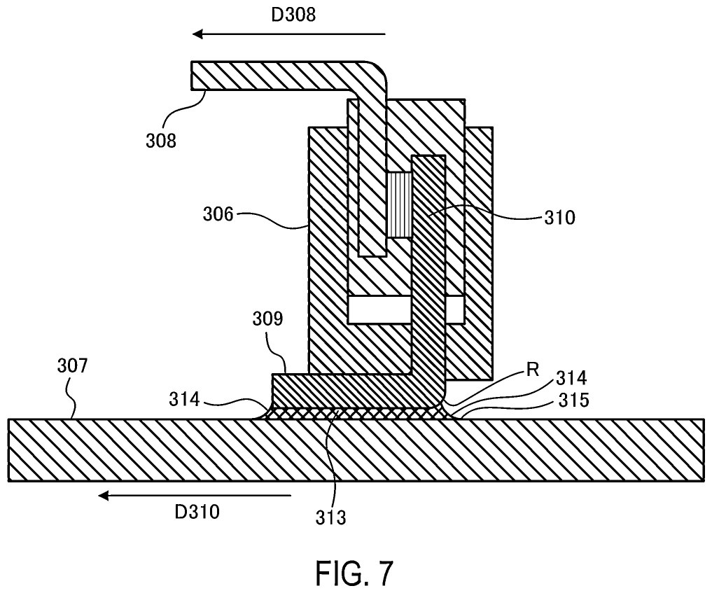

### DESCRIPTION OF THE EMBODIMENTS

An image forming apparatus provided with an optical scanning device according to an Embodiment of the present invention will be described. Incidentally, in the following description, first, an exemplification of the image forming apparatus provided with the optical scanning device according to the Embodiment of the present invention will be described, and next, the optical scanning device in the image forming apparatus will be described. And next, a deflector assembled in the optical scanning device will be described.

### [General Optical Scanning Device]

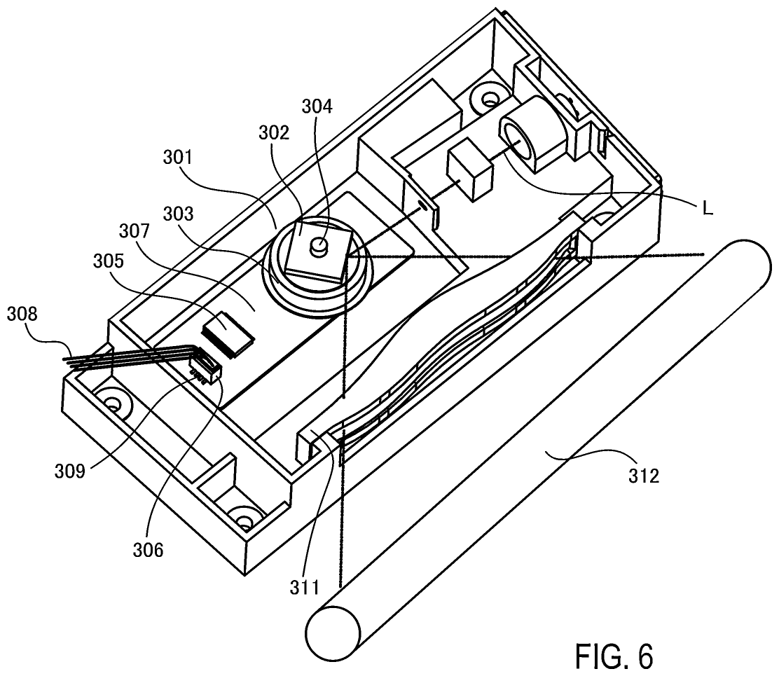

A light deflector (scanner motor) used in a general optical scanning device will be described using FIG. 6. FIG. 6 is a perspective view of a conventional optical scanning device. A scanner motor 301 is constituted by a rotating polygon mirror 302, a rotor 303, a rotation shaft 304 and a substrate 307. The rotor 303 is for rotating the rotating polygon mirror 302. The rotation shaft 304 is integrated with the rotor 303. A motor driver IC 305 controls the scanner motor 301. Electrical components such as the motor driver IC 305 and a connector 306 are mounted on the substrate 307. And, to the scanner motor 301, electric power and an electric signal to rotationally drive the rotor 303 is sent from an electric control board (not shown) via a connector cable 308 connected to the connector 306. A laser light L emitted from a semiconductor laser is deflected and scanned by the rotating polygon mirror 302. The laser light reflected by the rotating polygon mirror 302 is scanned on a scanned member 312 via an optical member 311.

### EMBODIMENT

### [Image Forming Apparatus]

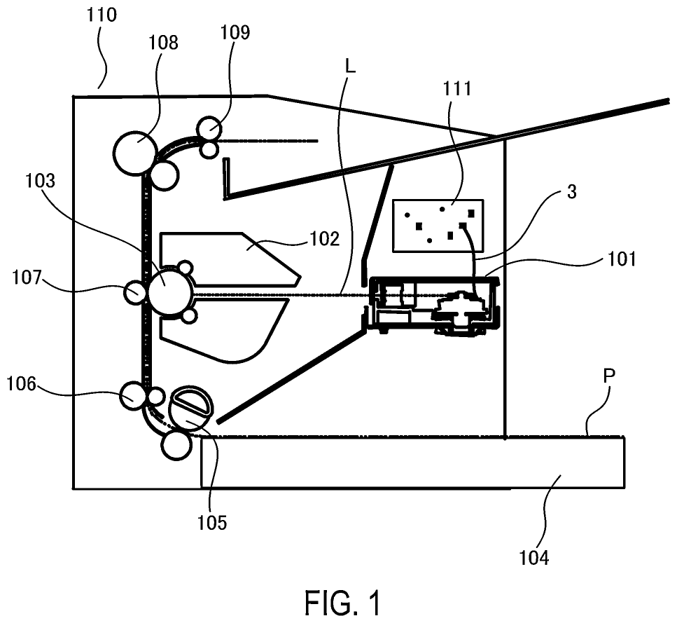

FIG. 1 is a schematic cross-sectional view illustrating an image forming apparatus in an Embodiment. The image forming apparatus in the present Embodiment is provided with an optical scanning device and an image forming means, which scans an image bearing member such as a photosensitive drum with the optical scanning device and performs an image formation on a recording material such as a recording paper based on the scanned image. Here, a printer is exemplified and described as the image forming apparatus. As shown in FIG. 1, an optical scanning device 101 emits a laser light L based on image information. The optical scanning device 101 is controlled by an electric control board 111 via a connector cable 3. The laser light L is irradiated on a photosensitive drum 103, which is both a scanned member and an image bearing member, embedded in a process cartridge 102. Then, a latent image is formed on the photosensitive drum 103, and the latent image is visualized into a toner image by toner as developer. Incidentally, the process cartridge 102 is what integrally includes the photosensitive drum 103 and a charging means, a developing means, etc. as a process means which act on the photosensitive drum 103.

On the other hand, a recording material P stacked on a stacking plate 104 is fed while being separated one by one by a feeding roller 105, and then conveyed further to a downstream side by an intermediate roller 106. On the conveyed recording material P, the toner image formed on the photosensitive drum 103 is transferred by a transfer roller 107 as a transfer means. The recording material P, on which the unfixed toner image is formed, is conveyed further to the downstream side. And, by a fixing device 108, which includes a heating member inside, the toner image is fixed to the recording material P. Then, the recording material P is discharged out of the apparatus by a discharging roller 109.

Incidentally, in the present Embodiment, it is configured that the charging means and the developing means as the process means which act on the photosensitive drum 103 are integrally provided to the process cartridge 102 together with the photosensitive drum 103, however, it may be configured that each process means is provided separately from the photosensitive drum 103. In addition, a configuration of the image forming apparatus is not limited to the configuration shown in FIG. 1, but may be a color image forming apparatus, etc., for example.

### [Optical Scanning Device]

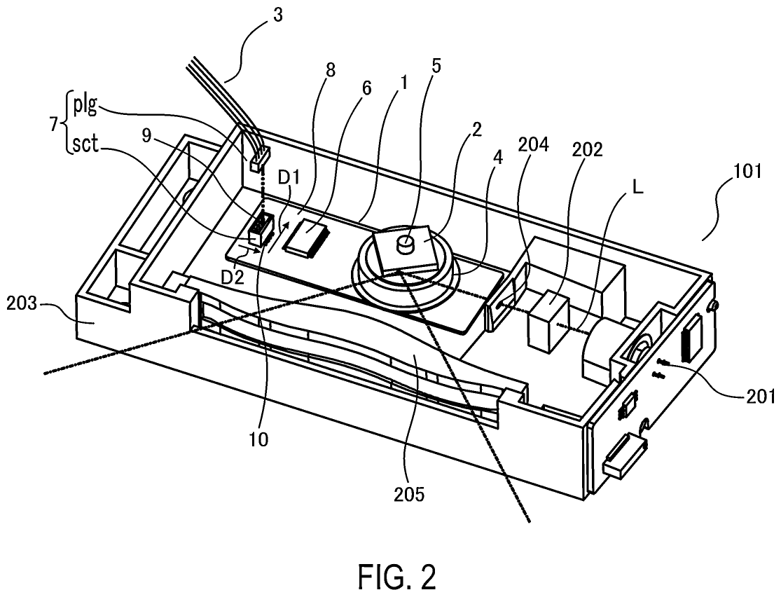

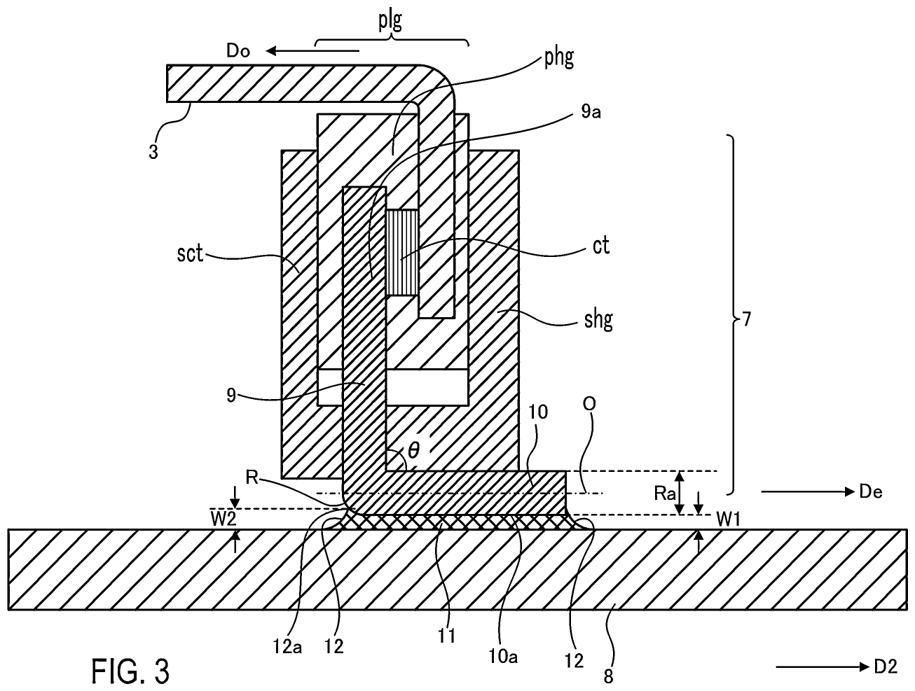

Next, an optical scanning device 101 in an image forming apparatus 110 will be described using FIG. 2 and FIG. 3. FIG. 2 is a perspective view illustrating a configuration of the optical scanning device 101 in the present Embodiment. Incidentally, in the description below, a direction in which a rotating polygon mirror 2 deflects the laser light L is referred to as a main scanning direction, and a direction perpendicular to the main scanning direction, in other words, a rotational direction of the photosensitive drum 103, is referred to as a sub scanning direction.

The laser light L emitted from a light source 201 is condensed only in the sub scanning direction by an anamorphic collimator lens 202, in which a collimator lens and a cylindrical lens are integrated, and is limited to a predetermined beam diameter by an optical aperture 204 formed in an optical box 203. Incidentally, as shown in FIG. 2, the light source 201 is provided on a side surface of the optical box 203. The laser light Lis deflected by the rotating polygon mirror 2, which is rotationally driven by a scanner motor 1, passes through a f lens 205, and then is irradiated on the photosensitive drum 103. By this, an electrostatic latent image is formed on the photosensitive drum 103. Incidentally, the light source 201, the anamorphic collimator lens 202, the scanner motor 1, etc. are accommodated in the optical box 203, and an opening of the optical box 203 is closed by an optical lid (not shown). In addition, the scanner motor 1 is rotationally driven at a predetermined number of rotation by electric power and an electric signal being supplied from the electrical control board 111 through the connector cable 3 (cable) in FIG. 1.

The scanner motor 1 is constituted by the rotating polygon mirror 2, which deflects the laser light L, a rotor 4, which rotates the rotating polygon mirror 2, a rotation shaft 5, which is integrated with the rotor 4, and a substrate 8, on which electric components such as a motor driver IC 6 and a connector 7 are mounted. The connector 7 includes a socket sct, which is mounted on the substrate 8, and a plug plg, which is connected to the socket sct. The socket sct includes an insulating housing shg and a terminal pin 9. The plug plg includes an insulating housing phg and a terminal ct, which is provided inside the housing phg. A conducting wire of the connector cable 3 is electrically connected to the terminal ct. The terminal ct has elasticity. When the plug plg is inserted into the socket sct, the terminal ct is elastically deformed by contacting the terminal pin 9, and the terminal ct and the terminal pin 9 are electrically connected. The socket sct of the connector 7 is provided with four terminal pins 9 of round shape. The connector 7 is a connector of straight type, of which the terminal pins 9 connected to the terminal ct extend vertically with respect to the substrate 8. And the terminal pins 9 of the connector 7 do not penetrate the substrate 8 and are mounted on the surface of the substrate 8 with low melting point solder (not shown). That is, not using a mounting method (through-hole technology (mount)), which fixes the terminal pins 9 to holes in the substrate 8, but using the surface mount technology, which does not insert the terminal pins 9 into the holes in the substrate 8, the terminal pins 9 are mounted on the substrate 8. In addition, the socket sct is provided so that a leading end of a solder bonding portion 10 of the four terminal pins 9 faces a direction (direction De) toward a position of the substrate 8, at which the rotating polygon mirror 2 is mounted. Furthermore, the connector cable 3 connected to the connector 7 is disposed so as to extend in an opposite direction Do to the direction De toward the leading end of the solder bonding portion 10 of the terminal pins 9 (opposite direction Do to the direction De toward the position of the substrate 8, at which the rotating polygon mirror 2 is mounted). Incidentally, as shown in FIG. 2, a longitudinal direction of connector 7 is referred to as D1, and a widthwise direction perpendicular to the longitudinal direction is referred to as D2. The plurality (four, in the present Embodiment) of terminal pins 9 of round shape are arranged along the longitudinal direction D1.

### [Bonding Portion Between the Connector and the Substrate]

Next, the bonding portion between the connector 7 and the substrate 8 will be described using FIG. 3. FIG. 3 is a cross-sectional view of the terminal pin 9 in a state in which the connector cable 3 is connected to the connector 7. Specifically, it is a cross-sectional view perpendicular to the longitudinal direction D1 and passing through either one terminal pin 9 of the plurality of the terminal pins 9.

As shown in FIG. 3, the terminal pin 9 of the connector 7 is bent substantially at right angle in only one direction, and the bent portion R is formed. The terminal pin 9 includes a contacting portion (vertical portion) 9a, which contacts “the terminal ct electrically connected to the connector cable 3”, and the solder bonding portion 10, which is soldered to the substrate 8 by low melting point solder 11. The terminal pin 9 includes the bent portion R, which connects the contacting portion 9a and the solder bonding portion 10 so that a direction, in which the contacting portion 9a extends, and a direction, in which the solder bonding portion 10 extends, differ. In the present Embodiment, the terminal pin 9 has a cylindrical shape, that is, a shape of a cross section thereof perpendicular to a direction, in which the terminal pin 9 extends, is circular.

Incidentally, the shape of the terminal pin 9 is not limited to the cylindrical shape, but may be other shapes such as an oval shape or a rectangular shape. A diameter of the solder bonding portion 10 is referred to as a diameter Ra.

The direction, in which the contacting portion 9a extends, is a direction crossing an imaginary surface, which is formed by the longitudinal direction D1 and the widthwise direction D2, and, in the present Embodiment, is a direction perpendicular to the imaginary surface. In the present Embodiment, an angle of the bent portion R, more specifically, an angle θ between the direction, in which the contacting portion 9a extends, and the direction, in which the solder bonding portion 10 extends, is 90°.

In the present Embodiment, the connector 7 is provided so that the imaginary surface, which is formed by the longitudinal direction D1 and the widthwise direction D2, is parallel to the substrate 8, therefore the contacting portion 9a is perpendicular to the substrate 8. In addition, the direction, in which the solder bonding portion 10 extends, is a direction away from the connector 7, and is the direction De.

When the solder bonding portion 10 of the terminal pin 9 is bonded to the substrate 8 by the low melting point solder 11, a fillet 12 is formed in the solder 11. A thickness of the low melting point solder 11 from the substrate 8 is configured to be a degree, in which the solder 11 does not overlap a center line O of the solder bonding portion 10 of round shape (cylindrical shape), and the fillet 12 is formed at the bent portion R. Incidentally, the center line O is an imaginary line which passes through a center of the circular cross section of the solder bonding portion 10 described above. In the solder bonding portion 10, a surface, which contacts the low melting point solder 11, is referred to as a surface 10a, and a thickness of the low melting point solder 11 between the surface 10a and the substrate 8 is referred to as a thickness W1. In addition, in the fillet 12 at the bent portion R, a portion, which a height thereof from the substrate 8 becomes highest, is referred to as a portion 12a, and a thickness of the low melting point solder 11 from the substrate 8 to the portion 12a is referred to as a thickness W2. In this case, as described above, the thickness W2 is configured to be in the degree not overlapping the center line O, i.e., (W1+Ra/2)>W2.

In addition, the connector cable 3 extends in the opposite direction Do, which is a second direction opposite to the leading end direction De, which is a first direction of the solder bonding portion 10 of the terminal pin 9, substantially without an excess length. Incidentally, in the leading end direction De, the rotating polygon mirror 2 is disposed. That is, in the present Embodiment, the connector 7 is soldered to the substrate 8 so that the rotating polygon mirror 2 is in the direction, in which the solder bonding portion 10 extends.

According to the present Embodiment, by configuring the optical scanning device 101 as described above, it becomes possible to obtain effect described below. That is, when the connector cable 3 is routed in a state connected to the connector 7, stress is exerted onto the connector 7 in the direction, in which the connector cable 3 extends, i.e., in the opposite direction Do to the leading end direction De of the solder bonding portion 10 of the terminal pin 9. At this time, in stress exerted onto the fillet 12, which is formed at the bent portion R of the terminal pin 9, a tensile component is reduced and a compressive component is added, therefore it becomes possible to suppress breakdown of the low melting point solder 11. Therefore, upon assembling the optical scanning device 101 and the image forming apparatus 110, it becomes possible to suppress the connector 7 of the scanner motor 1 from detaching from the substrate 8, therefore it becomes possible to provide the optical scanning device and the image forming apparatus, which are more reliable.

### Modified Example 1

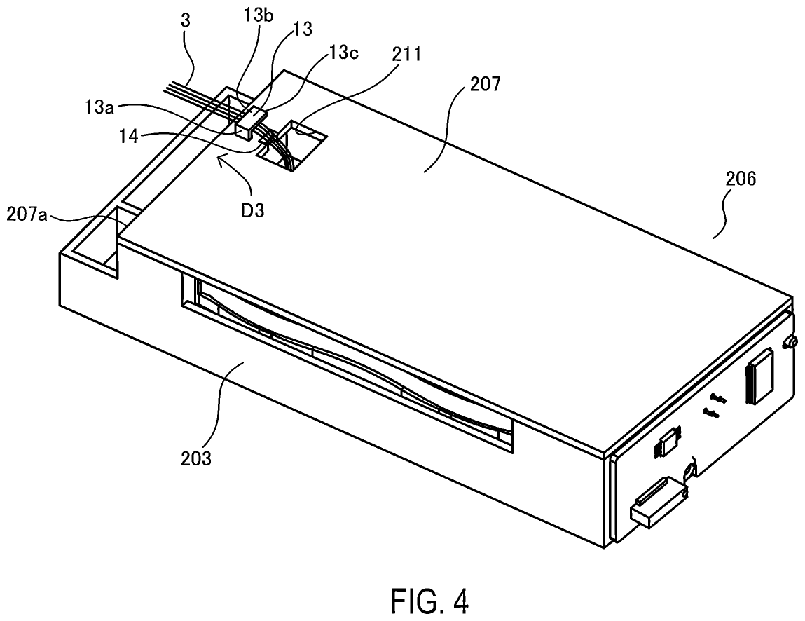

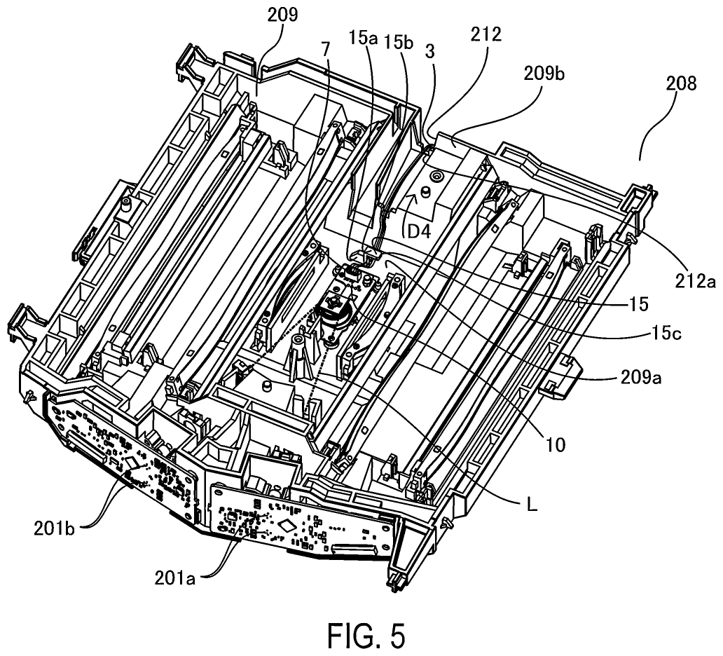

In addition, a Modified Example of the optical scanning device will be described using FIG. 4 and FIG. 5. FIG. 4 is a perspective view illustrating an optical scanning device 206, which is a Modified Example of the present Embodiment. In FIG. 4, the opening of the optical box 203 is covered by the optical lid 207 and the connector is not visible, however, the configuration of the connector is the same as the configuration described in FIG. 3, and the reference numerals described in FIG. 3, etc. will be used.

The optical lid 207 includes a hole 211, which penetrates the optical lid 207, to lead the connector cable 3 connected to the connector 7 to an outside of the optical scanning device 206. Upon referring to a direction perpendicular to the direction D1 and the direction D2 as a vertical direction, when the optical lid 207 is placed over the optical box 203, the hole 211 is provided so as to be positioned above (directly above) the connector 7. A direction, in which the connector cable 3 goes from an inside of the optical scanning device 206 through the hole 211 to the outside thereof, is referred to as a direction D3. The hole 211 includes a chamfer portion 14, which contacts the connector cable 3 extending in the direction D3.

The optical lid 207 includes an end portion 207a crossing the connector cable 3 routed through the hole 211. In the optical lid 207, a cable guide 13 is provided between the end portion 207a and the chamfer portion 14 of the hole 211. The cable guide 13 in the Modified Example 1 includes a connecting portion 13a, which is connected to the optical lid 207, and a restricting portion 13b, which is continued from the connecting portion 13a, covers at least a portion of the connector cable 3 and restricts moving of the connector cable 3 in a direction crossing the direction D3. In the Modified Example 1, the restricting portion 13b is configured to cover all of the connector cable 3. In the Modified Example 1, an end portion 13c of an opposite side to a side, to which the connecting portion 13a of the restricting portion 13b is connected, is configured to be an open end to improve workability upon passing the connector cable 3 through the cable guide 13, however, it is not limited thereto.

In FIG. 4, the connector cable 3 connected to the connector 7 is routed directly to the outside of the optical scanning device 206, and the cable guide 13, to which the connector cable 3 is hung, is provided in the optical lid 207. A position of the cable guide 13 is provided, with reference to the connector 7, in the opposite direction to the leading end direction of the solder bonding portion 10 of the terminal pin 9 of the connector 7.

By providing the cable guide 13, it becomes possible to regulate the direction in which the connector cable 3 is extended. In addition, by providing the chamfer portion 14 at a contacting portion between the optical lid 207 and the connector cable 3, it becomes possible to suppress wire breakage as well caused by the connector cable 3 contacting a corner portion of the optical lid 207. Incidentally, in case in which the connector cable 3 contacts the optical box 203, the cable guide 13 and/or the chamfer portion 14 may be provided in the optical box 203. In addition, in view of dust proof etc., the hole 211 may be covered.

Furthermore, in a case in which the connector cable 3 is routed on the optical lid 207 as in the Modified Example 1, it may be configured as following. That is, the leading end of the solder bonding portion 10 of the connector 7 may face the opposite direction to the rotating polygon mirror 2. In this case, the direction, in which the connector cable 3 is routed, is the opposite direction Do to the leading end direction De, and is the direction in which the rotating polygon mirror 2 is disposed. However, since the connector cable 3 is routed through the hole 211 over the connector 7, and on the optical lid 207 in the direction opposite to the direction D3 in FIG. 4, the connector cable 3 does not interfere with the rotating polygon mirror 2 and the optical members in the optical box 203 and does not obstruct a path of the laser light L.

### Modified Example 2

FIG. 5 is a view illustrating an optical scanning device 208, which is provided to a color image forming apparatus, and a plurality (for example, four) of light sources 201a and 201b are provided on a side surface 209b, which will be described below. FIG. 5 is a perspective view of the optical scanning device 208 as viewed from an opening side of an optical box 209. A configuration of the connector 7 in FIG. 5 is the same as the configuration described in FIG. 3, and the reference numerals described in FIG. 3, etc. will be used. The optical box 209 includes a bottom surface 209a and the side surface 209b stood from the bottom surface 209a and crossing the connector cable 3. Incidentally, the optical lid closes an opening (opening surface) formed by the side surfaces 209b.

On the side surface 209b, a cutaway portion 212 to lead the connector cable 3 connected to the connector 7 to an outside of the optical scanning device 208 is provided. A direction, in which the connector cable 3 goes from an inside of the optical scanning device 208 through the cutaway portion 212 to the outside thereof, is referred to as a direction D4. The cutaway portion 212 includes a chamfer portion 212a, which contacts the connector cable 3 extending in the direction D4.

In the optical box 209, a cable guide 15 is provided between the connector 7 and the cutaway portion 212. The cable guide 15 in the Modified Example 2 includes a connecting portion 15a, which is connected to the bottom surface 209a of the optical box 209, and the restricting portion 15b, which is continued from the connecting portion 15a, covers at least a portion of a radial direction of the connector cable 3 and restricts moving of the connector cable 3 in a direction crossing the direction D4. In the Modified Example 2, an end portion 15c of an opposite side to a side, to which the connecting portion 15a of the restricting portion 15b is connected, is configured to be an open end to improve workability upon passing the connector cable 3 through the cable guide 15, however, it is not limited thereto.

In FIG. 5, the connector cable 3 connected to the connector 7 is routed inside the optical scanning device 208, and the cable guide 15, on which the connector cable 3 is hung, is provided in the optical box 209. The cable guide 15 is provided, with reference to the connector 7, in the opposite direction Do to the leading end direction De of the solder bonding portion 10 of the terminal pin 9 of the connector 7.

By providing the cable guide 15, it becomes possible to route the connector cable 3 in a desired direction and avoid shading of the laser light L by the connector cable 3. In the Modified Example 2, the direction D4 is configured to be the same direction as the opposite direction Do to the leading end direction De of the solder bonding portion 10. In addition, since the connector cable 3 is routed along the bottom surface 209a, the connector cable 3 does not enter within a range of a scanning direction of the laser light L by the rotating polygon mirror 2. In addition, by passing the connector cable 3 through the cutaway portion 212, it becomes possible to suppress wire breakage due to the connector cable 3 being pinched between the optical box 209 and the optical lid (not shown). Incidentally, in view of dust proof, etc., the cutaway portion 212 may be covered.

In the present Embodiment described above, the connector cable connected to the connector is configured to be extended in the opposite direction to the leading end direction of the solder bonding portion of the terminal pin, which is a direction in which an optical element is not disposed. In a case in which the connector cable is extended in a direction, in which an optical element is disposed, the connector may be provided so that the leading end direction of the solder bonding portion of the terminal pin is opposite to the direction, in which the connector cable is extended. In this case, for example, as described at the end of the Modified Example 1, it may be configured that the connector cable is extended to the outside of the optical scanning device and the cable guide is provided in the optical lid. In addition, a position of the cable guide may be provided, with reference to the connector, in the opposite direction to the leading end direction of the solder bonding portion of the terminal pin of the connector.

As described above, according to the present Embodiment, in an assembly line of the scanning optical device and the image forming apparatus, it becomes possible to suppress the detachment of the connector of the scanner motor, which includes the connector of straight type mounted on the surface by solder.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-016440, filed on Feb. 6, 2024, which is hereby incorporated by reference herein in its entirety.

What is claimed is:

1. An optical scanning device comprising:
a light source configured to emit a laser light;
a rotating polygon mirror configured to deflect the laser light emitted from the light source;
an optical member configured to guide the laser light deflected by the rotating polygon mirror to a scanned member;
a motor configured to rotate the rotating polygon mirror;
a substrate on which the rotating polygon mirror and the motor are mounted;
an optical box configured to accommodate the substrate and the optical member;
an optical lid configured to close an opening surface of the optical box; and
a connector mounted on the substrate using a surface mount technology,
wherein the connector is provided with a plurality of terminal pins including vertical portions extending substantially in a vertical direction with respect to a plane of the substrate and bonding portions bonded to a surface of the substrate by solder,
wherein in the plurality of terminal pins, each of leading ends of the bonding portions faces in a same first direction, and
wherein in a state in which a cable which sends an electric power and an electric signal to the motor is connected to the connector, the cable is connected to the connector so as to extend in a second direction opposite to the first direction.

2. The optical scanning device according to claim 1, wherein the first direction is a direction in which the leading ends of the bonding portions face the rotating polygon mirror.

3. The optical scanning device according to claim 1, further comprising a cable guide configured to guide the cable,
wherein the cable guide is provided on a side opposite to the rotating polygon mirror with reference to the connector.

4. The optical scanning device according to claim 3, wherein the optical lid includes a hole configured to lead the cable connected to the connector from an inside to an outside of the optical box, and
wherein in a state in which the optical lid closes the opening surface, the cable guide is provided outside the optical lid and guides the cable led from the hole to the outside.

5. The optical scanning device according to claim 4, wherein in a state in which the cable is guided by the cable guide, the hole includes a chamfer portion at a position in contact with the cable.

6. The optical scanning device according to claim 3, wherein the optical box includes a bottom surface, and
wherein the cable guide is provided on the bottom surface.

7. The optical scanning device according to claim 6, wherein the optical box includes a side surface stood from the bottom surface,
wherein the side surface includes a cutaway portion configured to lead the cable, connected to the connector and guided by the cable guide, from an inside to an outside of the optical box.

8. The optical scanning device according to claim 7, wherein in a state in which the cable is guided by the cable guide, the cutaway portion includes a chamfer portion at a position in contact with the cable.

9. The optical scanning device according to claim 1, wherein the first direction is a direction in which the leading ends of the bonding portions face a direction opposite to a direction of the rotating polygon mirror, and
further comprising a cable guide provided outside the optical lid in a state in which the optical lid closes the opening surface and configured to guide the cable, the cable guide being provided in the second direction with reference to the connector.

10. The optical scanning device according to claim 9, wherein the optical lid includes a hole configured to lead the cable connected to the connector from an inside to an outside of an optical box, and
wherein in a state in which the optical lid closes the opening surface, the cable guide is provided outside the optical lid and guides the cable led from the hole to the outside.

11. The optical scanning device according to claim 10, wherein in a state in which the cable is guided by the cable guide, the hole includes a chamfer portion at a position in contact with the cable.

12. The optical scanning device according to claim 1, wherein the bonding portion is bonded to the substrate by low melting point solder.

13. The optical scanning device according to claim 1, wherein each of the terminal pins has a round shape.

14. An image forming apparatus comprising:
an optical scanning device according to claim 1;
an image bearing member which is the scanned member on which an electrostatic latent image is formed by the optical scanning device;
a developing means configured to develop the electrostatic latent image on the image bearing member with toner and to form a toner image; and
a transfer means configured to transfer the toner image onto a recording material.
